(19) United States
(12) Patent Application Publication
(10) Pub. No.: US 2026/0135395 A1
(43) Pub. Date: May 14, 2026

(54) BIDIRECTIONAL CHARGER, CHARGING SYSTEM, AND METHOD OF OPERATING THE SAME

(71) Applicant: FSP TECHNOLOGY INC., Taoyuan CIty (TW)

(72) Inventors: Kuan-Jung LEE, Taoyuan CIty (TW); Kuo-Chieh CHAN, Taoyuan CIty (TW)

(73) Assignee: FSP TECHNOLOGY INC., Taoyuan CIty (TW)

(21) Appl. No.: 19/380,734

(22) Filed: Nov. 5, 2025

(30) Foreign Application Priority Data
Nov. 13, 2024 (TW) 113143614

(51) Int. Cl. H02J 7/34; B60L 53/62; B60L 53/66; H02J 7/00

(52) U.S. Cl. CPC H02J 7/342; B60L 53/62; B60L 53/66; H02J 7/40; H02J 2207/20

(57) ABSTRACT

A bidirectional charger includes a power conversion circuit and a control module. The power conversion circuit is used to convert a first power source of an electronic device and a second power source of a battery module, and the control module selectively sets an operation mode of the power conversion circuit to a sink mode or a source mode by performing a handshake communication with the electronic device. When the operation mode is set to the sink mode, the control module controls the power conversion circuit to convert the first power source into the second power source to charge the battery module. When the operation mode is set to the source mode, the control module controls the power conversion circuit to convert the second power source into the first power source to provide power to the electronic device.

### CROSS-REFERENCE TO RELATED APPLICATION

This application claims benefit of priority to Taiwanese Patent Application No. 113143614 filed November 13, 2024, the entire contents of which are incorporated herein by reference.

### BACKGROUND

### TECHNICAL FIELD

The present disclosure relates to a charger, a charging system, and a method of operating the same, and more particularly to a bidirectional charger, a charging system, and a method of operating the same.

### DESCRIPTION OF RELATED ART

The statements in this section merely provide background information related to the present disclosure and do not necessarily constitute prior art.

As batteries and charging technologies are increasingly used and the technology of electric vehicles is maturing, more and more light vehicles are gradually replaced by battery-powered light electric vehicles (such as, but not limited to, electric bicycles, electric scooters, electric motorcycles, etc.). Especially in the field of bicycle technology, electric bicycles (E-Bikes) can replace traditional human pedaling with electric-assisted riding, and therefore electric bicycles (E-Bikes) are gradually becoming a new generation of short-distance transportation tools.

In the technical field of electric bicycles (E-Bikes), it is generally necessary to install a battery and a charger (referred to as a charging system) on the bicycle so that the battery can be used to supply power to the bicycle during riding. Moreover, when the battery is out of power, the charger converts external power to charge the battery. However, in the current technical field, due to the increasing popularity of portable electronic products (such as, but not limited to, mobile phones, laptops, tablet computers, etc.), and electric bicycles may also be equipped with electronic dashboards and other devices similar to tablet computers. When the bicycle can be used for electric riding, the battery may also play the role of powering such portable electronic products. However, in the technical field of current charging systems, since the charger is generally not a bidirectional charging device, an additional converter must be configured to convert power to power portable electronic products, which will cause the charging system to be bulky and cause obstacles to users when riding.

Therefore, how to design a bidirectional charger, a charging system, and a method of operating the same to achieve the bidirectional charging function without the need for additional converters, thereby reducing the size of the charging system has become a critical topic in this field.

### SUMMARY

In order to solve the above-mentioned problems, the present disclosure provides a bidirectional charger. The bidirectional charger couples to a battery module of an electric vehicle and an electronic device, and the bidirectional charger includes a power conversion circuit and a control module. The power conversion circuit converts a first power source provided by the electronic device into a second power source, or converts the second power source provided by the battery module into the first power source. The control module is coupled to the power conversion circuit, and selectively sets an operation mode of the power conversion circuit to a sink mode or a source mode by performing a handshake communication with the electronic device. When the control module sets the operation mode to the sink mode through the handshake communication, the control module controls the power conversion circuit to convert the first power source into the second power source to charge the battery module; when the control module sets the operation mode to the source mode through the handshake communication, the control module controls the power conversion circuit to convert the second power source into the first power source to provide power to the electronic device.

In one embodiment, the bidirectional charger further includes a module-side connection part. The module-side connection part is coupled to the battery module through a connection cable. The module-side connection part includes a positive terminal, a negative terminal, and a signal terminal. The positive terminal is coupled to the power conversion circuit. The negative terminal is coupled to the power conversion circuit, and the power conversion circuit transmits the second power source through the positive terminal and the negative terminal. The signal terminal is coupled to the control module, and the control module communicates with the battery module through the signal terminal to obtain a battery parameter of the battery module.

In one embodiment, the bidirectional charger further includes a connection cable configured to couple to the battery module, and the connection cable includes a positive connection wire, a negative connection wire, and at least one signal connection wire. The positive connection wire is coupled to the power conversion circuit. The negative connection wire is coupled to the power conversion circuit, and the power conversion circuit transmits the second power source through the positive connection wire and the negative connection wire. The at least one signal connection wire is coupled to the control module, and the control module communicates with the battery module through the at least one signal connection wire to obtain a battery parameter of the battery module. When the number of the at least one signal connection wire is plural, signal transmission types of the plurality of signal connection wires are different.

In one embodiment, the bidirectional charger further includes a housing, a first circuit board, a second circuit board, and a third circuit board. The housing accommodates the power conversion circuit and the control module. The first circuit board is disposed on an inner surface adjacent to the housing, and disposes the power conversion circuit. The second circuit board is disposed on another inner surface adjacent to the housing opposite to the first circuit board, and disposes a communication circuit. The third circuit board is disposed between the first circuit board and the second circuit board for configuring to dispose the control module. The third circuit board is coupled to the first circuit board and the second circuit board through a plurality of conductive components.

In one embodiment, a first accommodation space between the first circuit board and the third circuit board is larger than a second accommodation space between the second circuit board and the third circuit board, and a power inductor and a power capacitor of the power conversion circuit are disposed in the first accommodation space.

In one embodiment, the number of layers of the first circuit board is greater than that of the second circuit board and the third circuit board.

In one embodiment, the third circuit board includes a shielding layer, and the shielding layer suppresses noise generated by the power conversion circuit during operation.

In one embodiment, the control module obtains a preset battery voltage corresponding to a number of batteries connected in series in the battery module according to a battery parameter of the battery module so as to control the power conversion circuit to provide the second power source to charge the battery module according to the preset battery voltage.

In one embodiment, the bidirectional charger further includes a correction module configured to couple to the control module. The correction module corrects a second battery voltage actually provided by the power conversion circuit according to a first battery voltage preset by the control module so as to correct the second battery voltage to be substantially equal to the first battery voltage.

In one embodiment, the control module includes a power delivery controller and a controller. The power delivery controller performs the handshake communication with the electronic device through a power delivery charging protocol to adjust the first power source, and the controller adjusts the second power source according to a battery parameter of the battery module in the sink mode.

In one embodiment, when the control module has not yet completed the handshake communication with the electronic device, the control module controls the power conversion circuit to adjust a voltage of the first power source to a default voltage, and when the control module completes the handshake communication with the electronic device and sets the operation mode to the source mode, the control module controls the power conversion circuit to convert the second power source to the first power source that meets requirements of the electronic device to supply power to the electronic device.

In order to solve the above-mentioned problems, the present disclosure provides a charging system. The charging system couples to a battery module of an electric vehicle, and the charging system includes a power supplying device, a power conversion circuit, and a control module. The power supplying device converts an input power into a first power source. The power conversion circuit converts the first power source provided by the power supplying device into a second power source. The control module is coupled to the power conversion circuit, and confirms a power supplying capability of the power supplying device to select a maximum power supplying parameter from the power supplying capability by performing a handshake communication with the power supplying device. The power supplying device knows the power supplying parameter through the handshake communication, and converts the input power into the first power source corresponding to the power supplying parameter.

In order to solve the above-mentioned problems, the present disclosure provides a method of operating a bidirectional charger. The bidirectional charger couples to a battery module of an electric vehicle and an electronic device, and the bidirectional charger includes a power conversion circuit. The method includes steps of: (a) confirming that the electronic device is connected to the bidirectional charger, and determining whether the electronic device is a power supplying device or a power receiving device; (b1) confirming that the electronic device is the power supplying device, and receiving a first power source provided by the power supplying device; (c) setting a current upper limit of a second power source provided to the battery module to a default current, and detecting a battery voltage of the battery module; (d) determining whether the battery voltage is less than a preset voltage; (e1) maintaining the current upper limit at the default current according to the battery voltage being less than the preset voltage, and controlling the power conversion circuit to convert the first power source into the second power source according to the default current.

In one embodiment, the method includes steps of: (b11) confirm a power supplying capability of the power supplying device by performing a handshake communication with the power supplying device, and selecting a maximum power supplying parameter from the power supplying capability to receive the first power source corresponding to the power supplying parameter, and setting the current upper limit to a predetermined current corresponding to the power supplying parameter according to the battery voltage not being lower than the predetermined voltage, and controlling the power conversion circuit to convert the first power source into the second power source according to the predetermined current.

In one embodiment, the method includes a step of: (f) determining whether a current of the second power source is less than a threshold current, and returning to step (d) according to the current being not less than the threshold current.

In one embodiment, the method includes a step of: (a1) performing a handshake communication with the electronic device, and controlling the power conversion circuit to adjust a voltage of the first power source to a default voltage.

In one embodiment, the method further a step of: (b2) confirming that the electronic device is the power receiving device, and controlling the power conversion circuit to convert the second power source into the first power source that meets requirements of the electronic device to supply power to the electronic device.

In one embodiment, the method further includes steps of: (b3) failing to determine whether the electronic device is the power supplying device or the power receiving device, (g) reperforming the handshake communication to redetermine whether the electronic device is the power supplying device or the power receiving device, and counting the number of times the electronic device is redetermined, and (h1) setting the electronic device as the power receiving device when the number is greater than an upper limit, and entering step (b2).

In one embodiment, the method further includes a step of: (h2) returning to step (g) when the number is not greater than the upper limit.

In one embodiment, the method further includes steps of: (h3) returning to step (b2) when the number is not greater than an upper limit, and the electronic device is confirmed as the power receiving device, or (h4) returning to step (b1) when the number is not greater than the upper limit, and the electronic device is confirmed as the power supplying device.

The main purpose and effect of the present disclosure is that since the bidirectional charger of the present disclosure uses the handshake communication technology to adjust the first power source or the second power source provided by the power conversion circuit, the bidirectional charger of the present disclosure can achieve the bidirectional charging function without additionally configuring a converter, thereby reducing the volume of the charging system.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a bidirectional charger according to the present disclosure.

FIG. 2A is a structural appearance diagram of the bidirectional charger according to a first embodiment of the present disclosure.

FIG. 2B is a structural appearance diagram of the bidirectional charger according to a second embodiment of the present disclosure.

FIG. 3 is a circuit structure diagram of the bidirectional charger according to the present disclosure.

FIG. 4A is a block circuit diagram of a control module according to the present disclosure.

FIG. 4B is a functional schematic diagram of the bidirectional charger set to a sink mode according to the present disclosure.

FIG. 4C is a flowchart of a method of operating the bidirectional charger set to a source mode according to the present disclosure.

FIG. 5A is a first flowchart of a method of operating the bidirectional charger set to a sink mode according to the present disclosure.

FIG. 5B is a second flowchart of a method of operating the bidirectional charger set to a sink mode according to the present disclosure.

FIG. 5C is a flowchart of a method of failing to determine an electronic device by the bidirectional charger according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

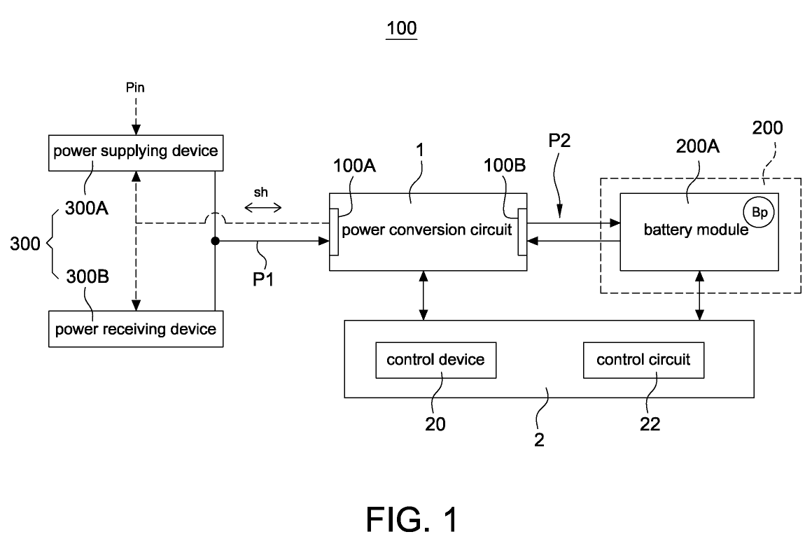

Please refer to FIG. 1, which shows a block circuit diagram of a bidirectional charger according to the present disclosure. One terminal of the bidirectional charger 100 is used to couple to a battery module 200A of the electric vehicle 200, and the other terminal of the bidirectional charger 100 is coupled to the electronic device 300. The electronic device 300 may be a power supplying device 300A (for example but not limited to, an adapter, a power supply, etc. that can provide power ranging from 20V to 48V) or a power receiving device 300B (for example but not limited to, a mobile phone, a smart watch, a laptop, etc. that can receive power ranging from 5V to 20V), and the bidirectional charger 100 may be adjusted to a sink mode SK or a source mode SO according to the type of the electronic device 300, which is a power supplying device 300A or a power receiving device 300B, to charge and discharge the battery module 200A. The electric vehicle 200 may preferably be an electric bicycle, but is not limited thereto, and may also be a mobile vehicle such as an electric scooter or an electric motorcycle.

Furthermore, the bidirectional charger 100 includes a power conversion circuit 1 and a control module 2. The power conversion circuit 1 may be, for example but not limited to, a flyback, LLC, buck-boost conversion circuit, and may preferably be an isolated conversion circuit having a transformer to electrically isolate the input terminal and the output terminal. Moreover, the power conversion circuit 1 has a bidirectional power conversion function, which can mainly be used to convert the first power source P1 provided by the electronic device 300 into the second power source P2 (when the electronic device 300 may be a power supplying device 300A, the power supplying device 300A may convert the input power Pin into the first power source P1), or convert the second power source P2 provided by the battery module 200A into the first power source P1.

The control module 2 may include at least one control device 20 (for example but not limited to, a microcontroller MCU, a processor CPU, and other control devices) and a control circuit 22 (for example but not limited to, a circuit for the controller to perform detection, compensation, and driving operations), and the control device 20 may have a power delivery (PD) charging protocol, and enable the bidirectional charger 100 to couple to the electronic device 300 through, for example but not limited to, the Type-C port 100A, to achieve the demand for high-speed charging and discharging. The control module 2 is coupled to the power conversion circuit 1, and the type of the electronic device 300 is obtained by a handshake communication Sh with the electronic device 300 so as to selectively set the operation mode of the power conversion circuit 1 to the sink mode SK or the source mode SO according to whether the type of the electronic device 300 is a power supplying device 300A or a power receiving device 300B. Moreover, the control module 2 may be coupled to the battery module 200A through the control circuit 22 so that the control device 20 can obtain battery parameters Bp of the battery module 200A, and control and adjust the second power source P2 accordingly.

When the control module 2 realizes that the electronic device 300 is a power supplying device 300A through the handshake communication Sh, the control module 2 sets the operation mode to the sink mode SK, and the control module 2 controls the power conversion circuit 1 to convert the first power source P1 into the second power source P2 so as to provide the second power source P2 to the battery module 200A and charge the battery module 200A. On the contrary, when the control module 2 realizes that the electronic device 300 is a power receiving device 300B through the handshake communication Sh, the control module 2 sets the operation mode to the source mode SO, and the control module 2 controls the power conversion circuit 1 to convert the second power source P2 provided by the battery module 200A into the first power source P1 so as to provide the first power source P1 to the electronic device 300 and provide power to the power receiving device 300B. In particular, in one embodiment, if not specifically specified in the present disclosure, the “power source” may be a general term for voltage, current or power, that is, the power source may be expressed as power, and the power may be obtained by multiplying the voltage and the current.

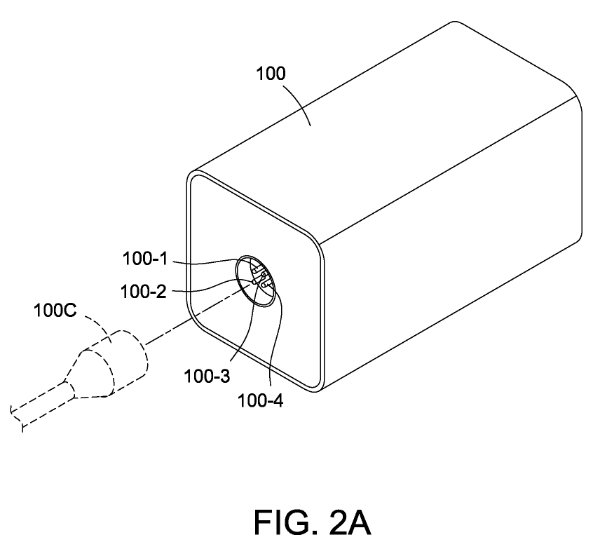

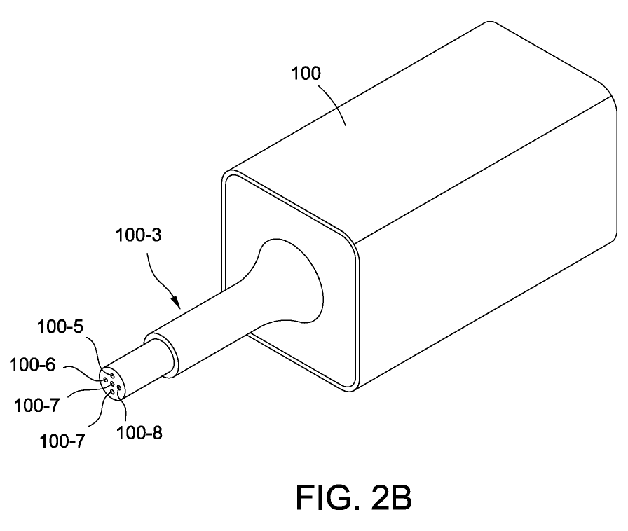

Please refer to FIG. 2A and FIG. 2B, which show structural appearance diagrams of the bidirectional charger according to a first embodiment and a second embodiment of the present disclosure respectively, and also refer to FIG. 1. In FIG. 2A, the bidirectional charger 100 includes a module-side connection part 100B, and the module-side connection part 100B is used to couple to the battery module 200A through a connection cable 100C. Furthermore, the module-side connection part 100B is a standard connection specification of the public standard (for example but not limited to, three pins or four pins), and the module-side connection part 100B includes a positive terminal 100-1, a negative terminal 100-2, and a signal terminal 100-3. The positive terminal 100-1 and the negative terminal 100-2 are coupled to the power conversion circuit 1, and when the battery module 200A is plugged into the bidirectional charger 100 through the connection cable 100C, the power conversion circuit 1 can couple to the positive and negative terminals of the battery module 200A through the positive terminal 100-1 and the negative terminal 100-2 to transmit the second power source P2.

The signal terminal 100-3 is coupled to the control module 2, and when the battery module 200A is plugged into the bidirectional charger 100 through the connection cable 100C, the control module 2 can be coupled to the battery module 200A through the signal terminal 100-3 to communicate with the battery module 200A and obtain the battery parameters Bp of the battery module 200A. Moreover, when the module-side connection part 100B is a four-pin design, the module-side connection part 100B may also include a grounding terminal 100-4. The grounding terminal 100-4 can couple to the power conversion circuit 1 and the control module 2, and when the battery module 200A is plugged into the bidirectional charger 100 through the connection cable 100C, the power conversion circuit 1, the control module 2 and the battery module 200A can connect their own ground paths together through the grounding terminal 100-4. Furthermore, since the module-side connection part 100B is a pluggable structure, the consumable connection cable 100C can be easily replaced to avoid the connection cable 100C having poor contact and being forced to replace the entire battery module 200A. Therefore, the bidirectional charger 100 of the present disclosure can adapt to the special interfaces of different battery terminals through the structural design of the replaceable connection cable 100C to achieve the effect of improving the convenience of use.

The difference between FIG. 2B and FIG. 2A is that the connection cable 100C is not a pluggable structure so that it does not need to be designed according to the standard connection specifications of the module-side connection part 100B as in FIG. 2A. Therefore, in addition to including a positive connection wire 100-5, a negative connection wire 100-6 and/or a grounding wire 100-8 having functions similar to the positive terminal 100-1, the negative terminal 100-2, and/or the grounding terminal 100-4 of FIG. 2A, the connection cable 100C also includes at least one signal connection wire 100-7. In particular, when the signal connection wire 100-7 is singular, the function of the signal connection wire 100-7 is similar to the signal terminal 100-3 of FIG. 2A. Moreover, when the signal connection wire 100-7 is plural (for example but not limited to, five pins or six pins), the applicable signal transmission type (for example but not limited to, CAN, I²C) is wider.

Specifically, the control module 2 may include a variety of detections of the battery module 200A (for example but not limited to, detection of voltage, current, power, temperature, etc.) and communication means (battery specifications, upper and lower limits of specifications, etc.). Therefore, if there is only one signal connection wire 100-7 (the same as FIG. 2A), the transmission of the signal must be converted to a unified specification (for example but not limited to, a 10kHz pulse), which will inevitably affect the speed of signal transmission. However, if there are multiple signal connection wires 100-7, the transmission of the signal does not need to be forced to be converted to a unified specification (for example but not limited to, pulses of different frequencies, analog signals, digital signals, etc.) due to the fact that there is only a single signal connection wire 100-7. Therefore, when there are multiple signal connection wires 100-7, the speed of signal transmission is faster.

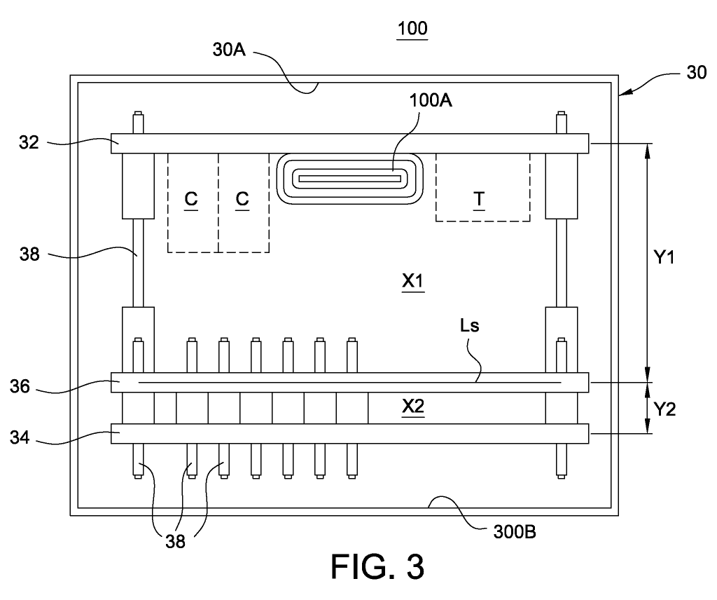

Please refer to FIG. 3, which shows a circuit structure diagram of the bidirectional charger according to the present disclosure, and also refer to FIG. 1 to FIG. 2B. In terms of structure, the bidirectional charger 100 includes a housing 30, a first circuit board 32, a second circuit board 34, and a third circuit board 36. The housing 30 is used to accommodate the power conversion circuit 1 and the control module 2. The first circuit board 32 is disposed on an inner surface 30A adjacent to the housing 30, and used to dispose the power conversion circuit 1 for large power conversion. The second circuit board 34 is disposed on another inner surface 30B adjacent to the housing 30 opposite to the first circuit board 32, and used to dispose a communication circuit. In particular, the communication circuit may include, for example but not limited to, a communication structure such as a controller area network (CAN bus), and may be used to transmit, for example but not limited to, high-speed signals such as Tx and Rx.

The third circuit board 36 is disposed between the first circuit board 32 and the second circuit board 34, and used to dispose the control module 2. The third circuit board 36 is coupled to the first circuit board 32 and the second circuit board 34 through a plurality of conductive components 38 so that the control module 2 is electrically connected to the power conversion circuit 1 and the communication circuit, and performs operations such as communication, detection, and control on the power conversion circuit 1 and the communication circuit through the conductive components 38. In particular, the conductive component 38 may be, for example but not limited to, a conductive component such as a copper needle, a copper bar, or a copper column. Furthermore, since the first circuit board 32 is used to dispose the power conversion circuit 1 for large power conversion, the current flowing through the first circuit board 32 is relatively large, and has components such as but not limited to, power capacitors C (generally electrolytic capacitors, but not limited thereto), power inductors, transformers T, power switches, etc. that are relatively large and prone to heat. Therefore, it is a preferred embodiment that a first accommodation space X1 between the first circuit board 32 and the third circuit board 36 is larger than a second accommodation space X2 between the second circuit board 34 and the third circuit board 36.

Furthermore, in order to easily accommodate components with a greater height (generally a power capacitor C, but not limited thereto), a ratio of the first distance Y1 between the first circuit board 32 and the third circuit board 36 to a second distance Y2 between the second circuit board 34 and the third circuit board 36 is, for example but not limited to, 6:1 to 7:1, which is a preferred implementation. In addition, the Type-C port 100A is also a component with a larger volume, and a large current will be transmitted through the Type-C port 100A, and therefore the Type-C port 100A is preferably also configured in the first accommodation space X1, but not limited thereto. Therefore, components with a larger volume and easy to generate heat, such as power capacitors C, transformers T, and power switches, can be configured in the first accommodation space X1 with a larger space so that the bidirectional charger 100 can achieve the effect of reducing the volume and increase the power density by using stacked plates and special component configuration (for example but not limited to, under the condition of 240W, the length, width and height of the housing 30 of the bidirectional charger 100 may be limited to 80.0 mm * 36.4 mm * 30.5 mm).

In addition, since the current flowing through the first circuit board 32 is relatively large, the heat accumulation of the first circuit board 32 is relatively high (compared to the second circuit board 34 and the third circuit board 36) when the bidirectional charger 100 performs charging and discharging operations. Therefore, in addition to independently configuring the first circuit board 32 on an inner surface 30A adjacent to the housing 30, the present disclosure further designs the number of layers of the first circuit board 32 (for example but not limited to, 6 to 8 layers) to be greater than that of the second circuit board 34 and the third circuit board 36 (for example but not limited to, each having less than 4 layers) to increase the heat dissipation efficiency of the first circuit board 32 and consequently enhance the heat dissipation capacity of the bidirectional charger 100.

On the other hand, since the second circuit board 34 preferably needs to be able to transmit high-speed signals, and the transmission of high-speed signals is easily distorted by interference from large currents, the present disclosure configures the first circuit board 32 carrying high currents and the second circuit board 34 carrying high-speed signals on two different sides of the third circuit board 36 respectively so as to effectively isolate the two circuit boards, thereby suppressing the noise generated by the power conversion circuit 1 during operation from interfering with the signal transmission of the communication circuit. Moreover, the third circuit board 36 may also selectively include a shielding layer Ls so that the shielding layer Ls can further suppress the noise generated by the power conversion circuit 1 during operation, thereby greatly reducing noise interference when the bidirectional charger 100 is in operation. In particular, the shielding layer Ls may preferably be a grounding layer coupled to the grounding terminal 100-4 or the grounding wire 100-8 so as to provide the bidirectional charger 100 with grounding and can also be used to suppress noise, thereby achieving the effect of reducing the number of the layers of the third circuit board 36.

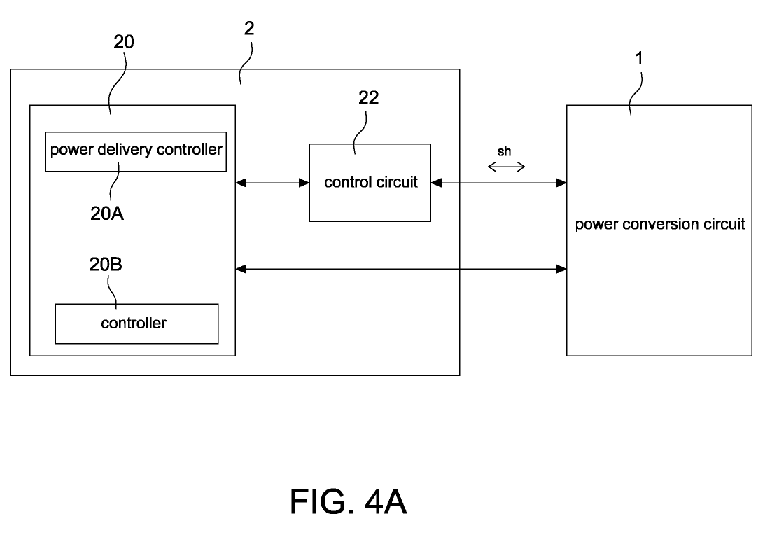

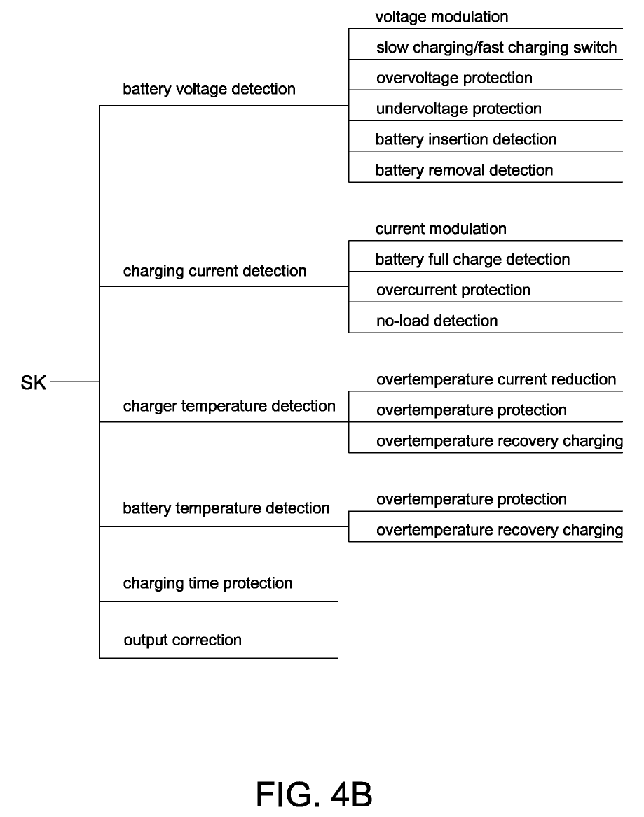

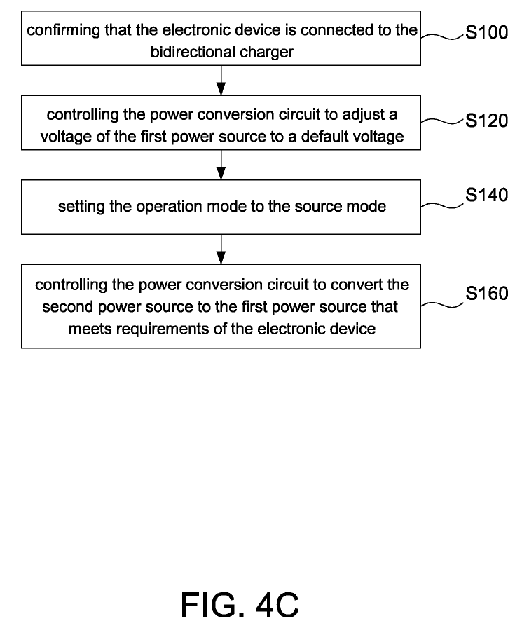

Please refer to FIG. 4A, which shows a block circuit diagram of a control module according to the present disclosure, and also refer to FIG. 1 to FIG. 3. The control device 20 of the control module 2 includes a power delivery controller 20A and a controller 20B. The power delivery controller 20A and the controller 20B may selectively couple the power conversion circuit 1 through the control circuit 22 to perform detection, control and other operations on the power conversion circuit 1. The power delivery controller 20A implements a power delivery charging protocol, and perform a handshake communication Sh with the electronic device 300 under the specification of the power delivery charging protocol (through the control circuit 22) so that the bidirectional charger 100 and the electronic device 300 can know each other’s power supply capacity and power demand, and adjust a first power source P1 accordingly (for example but not limited to, adjust a voltage level of the first power source P1 to 3V, 20V). Moreover, the controller 20B can adjust a second power source P2 provided by the power conversion circuit 1 according to the battery parameter Bp of the battery module 200A (also through the control circuit 22), and in the sink mode SK, the controller 20B adjusts the second power source P2 provided by the power conversion circuit 1 according to the battery parameter Bp.

Please refer to FIG. 4B, which shows a functional schematic diagram of the bidirectional charger set to a sink mode according to the present disclosure, and also refer to FIG. 1 to FIG. 4A. In FIG. 4B, the bidirectional charger 100 is adjusted to the sink mode SK when the electronic device 300 is identified as the power supplying device 300A. In the sink mode SK, the control module 2 controls the power conversion circuit 1 to convert the first power source P1 provided by the electronic device 300 into the second power source P2 to charge the battery module 200A. Moreover, the control module 2 can perform detection, control, and protection functions of battery voltage detection, charging current detection, charger temperature detection, battery temperature detection, charging time protection, and output correction for the battery module 200A. One of the features of these detection and protection functions is that the battery voltage detection includes a control function of voltage modulation. Specifically, the battery module 200A includes a plurality of batteries inside, and the batteries are connected in series or in parallel to form the battery module 200A. In the function of voltage modulation, the control module 2 can obtain a preset battery voltage according to the battery parameter Bp of the battery module 200A, and the number of series-connected batteries can be known through the preset battery voltage.

Specifically, since the specifications of the batteries should be the same (for example but not limited to, 18650 battery or 21700 battery), and such batteries generally have a platform voltage, when the batteries are not over-discharged, the battery voltage of the batteries will be roughly equal to the platform voltage. Therefore, knowing the preset battery voltage can reveal the number of series-connected batteries (for example but not limited to, 10 in series, 13 in series). Moreover, since the control module 2 can obtain the preset battery voltage according to the battery parameter Bp of the battery module 200A, the power conversion circuit 1 can be controlled to adjust the battery voltage of the second power source P2 to meet the preset battery voltage so as to provide the second power source P2 that meets the voltage requirement of the battery module 200A to charge the battery module 200A.

Moreover, another feature of these detection and protection functions is that the sink mode SK includes a control function of output correction. Specifically, the bidirectional charger 100 can correct the battery voltage of the second power source P2 through a correction module. That is, the correction module is used to couple to the control module 2, and the control module 2 (or the control module 2 acting through the correction module) can preset the first battery voltage of the second power source P2 (for example but not limited to, 36V) through the correction module. Afterward, the control module 2 controls the power conversion circuit 1 to convert the first power source P1 into the second power source P2, and detects the second power source P2 to determine the second battery voltage (for example but not limited to, 37V) actually provided by the power conversion circuit 1. Finally, the correction module corrects the control module 2 (for example but not limited to, by adjusting the reference voltage, etc.) according to the voltage difference between the preset first battery voltage (36V) and the actual second battery voltage (37V) to correct the second battery voltage to be substantially equal to the first battery voltage thereby increasing the accuracy of the bidirectional charger 100 in converting the second power source P2.

In particular, the control function of output correction of the bidirectional charger 100 can be calibrated by the factory fixture (i.e., the correction module) before leaving the factory, or the correction module can be additionally configured inside the bidirectional charger 100 (i.e., the correction module is additionally configured with circuits or is integrated into the control module 2) so that the bidirectional charger 100 can calibrated the second power source P2 at any time after leaving the factory. Moreover, the control function of FIG. 4B can be completed by the controller 20B, the control circuit 22, and/or the power delivery controller 20A of FIG. 4A, and the actual operation that can be inferred by those skilled in the art will not be described in detail here.

Please refer to FIG. 4C, which shows a flowchart of a method of operating the bidirectional charger set to a source mode according to the present disclosure, and also refer to FIG. 1 to FIG. 4B. In FIG. 4C, the electronic device 300 is plugged into the Type-C port 100A of the bidirectional charger 100 whereby the bidirectional charger confirms that the electronic device is connected (S100). Since the electronic device 300 has just been connected, the electronic device 300 and the bidirectional charger 100 have not yet completed the handshake communication Sh, and therefore the control module 2 controls the power conversion circuit 1 to adjust the voltage of the first power source P1 to a default voltage (S120). The reason why the control module 2 controls the power conversion circuit 1 to adjust the voltage of the first power source P1 to the default voltage (for example but not limited to, 5V) is that the control module 2 has not yet determined the type of the electronic device 300 and cannot confirm whether it should be adjusted to the sink mode SK or the source mode SO. Therefore, the default voltage (for example but not limited to, 5V) is provided to ensure that both parties are powered on so as to smoothly perform the handshake communication Sh.

Afterward, when the control module 2 and the electronic device 300 complete the handshake communication Sh and confirm that the electronic device 300 is the power receiving device 300B, the control module 2 sets the operation mode to the source mode SO (S140). In the source mode SO, the control module 2 can set the source mode SO to PD 3.0 power supply (Standard Power Range; SPR, maximum 100W output) or PD 3.1 power supply (Extend Power Range; EPR, maximum 240W output) according to the power demand of the power receiving device 300B. Finally, the control module 2 controls the power conversion circuit 1 to convert the second power source P2 into the first power source P1 that meets the requirements of the electronic device 300 (S160). After the control module 2 confirms the source mode SO and the requirements of the power receiving device 300B, the control module 2 controls the power conversion circuit 1 to adjust the voltage of the first power source P1 from the default voltage to a voltage level that meets the requirements of the power receiving device 300B (for example but not limited to, 5V to 20V). Therefore, the first power source P1 that meets the power requirements of the electronic device 300 (i.e., the power receiving device 300B) can be provided to power the electronic device 300 (i.e., the power receiving device 300B).

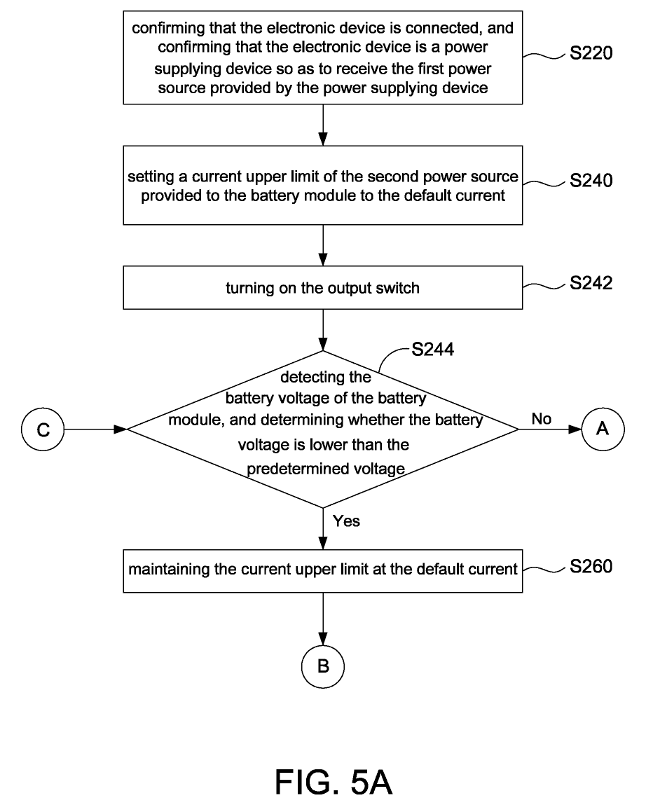

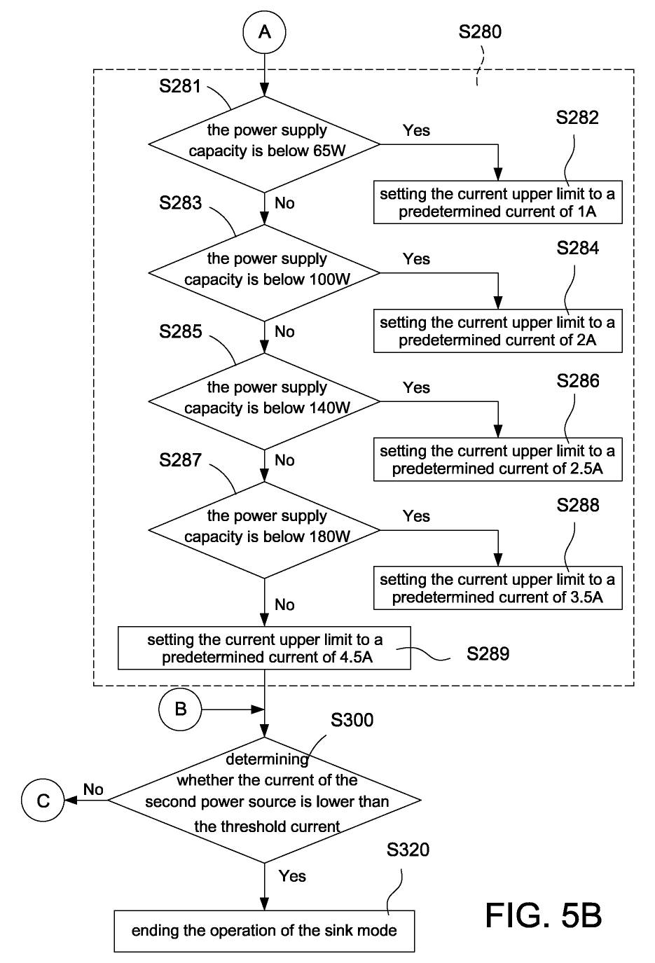

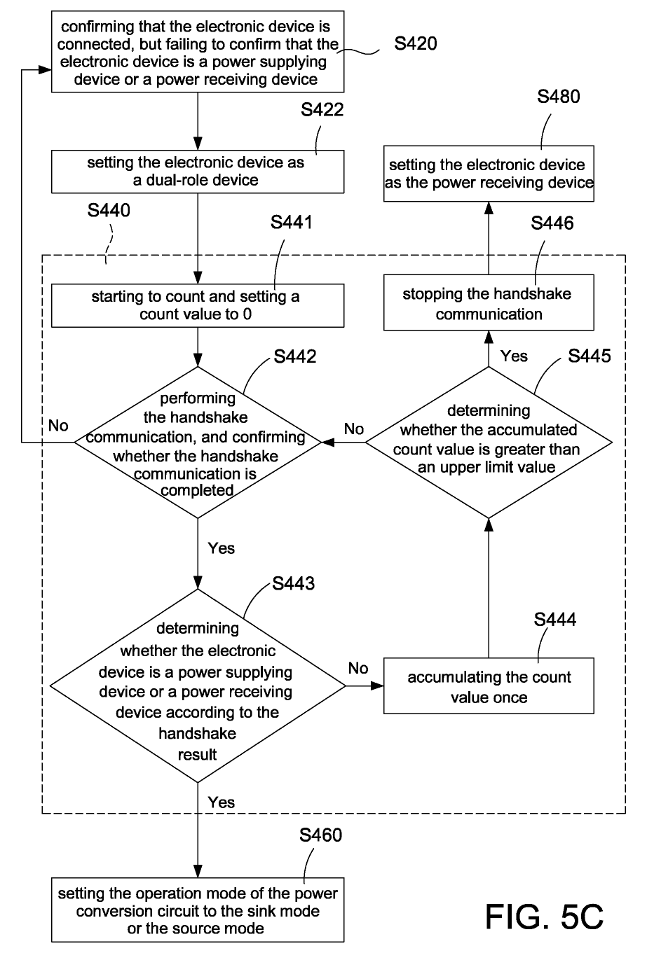

Please refer to FIG. 5A and FIG. 5B, which show a first flowchart and a second flowchart of a method of operating the bidirectional charger set to a sink mode according to the present disclosure respectively, and also refer to FIG. 1 to FIG. 4C. In FIG. 5A and FIG. 5B, the electronic device 300 is plugged into the Type-C port 100A of the bidirectional charger 100 so that the bidirectional charger 100 confirms that the electronic device 300 is connected, and confirms that the electronic device 300 is a power supplying device 300A so as to receive the first power source P1 provided by the power supplying device 300A (S220). In the operation of step (S220), the operation method is similar to steps (S100) to (S140), except that the control module 2 confirms that the electronic device 300 is a power supplying device 300A, and receives the first power source P1 provided by the power supplying device 300A. During the handshake communication Sh between the control module 2 and the power supplying device 300A, the control module 2 can confirm the power supply capacity of the power supplying device 300A. For example but not limited to, the power supplying device 300A supports PD 2.0, PD 3.0, and PD 3.1 power supply, and its power supply capacity is 100W, 100W, and 240W respectively. Moreover, with a power supply capacity of 240W, the generally supported power supplying parameters include 5V3A, 9V3A, 12V3A, 15V3A, 20V5A, 28V5A, 36V5A, and 48V5A.

The control module 2 can select the maximum power supplying parameter (i.e., 48V5A) from the power supply capacity (i.e., under the condition of 240W) to notify the power supplying device 300A through the handshake communication Sh. Consequently, the power supplying device 300A can know that the power supplying parameter is 48V5A through the handshake communication Sh so as to convert the input power Pin into the first power source P1 corresponding to the power supplying parameter according to the specification of the power supplying parameter. That is, the power supplying device 300A can provide a current of 0A to 5A according to the requirements of the bidirectional charger 100 under the condition of 48V. Afterward, a current upper limit of the second power source P2 provided to the battery module 200A is set to the default current (S240). The main reason why the control module 2 sets the default current (for example but not limited to, 1A) is to prevent the battery module 200A from suddenly receiving an excessive current and impacting its internal components when the control module 2 controls the power conversion circuit 1 to provide the second power source P2, which could otherwise easily damage the battery module 200A. Therefore, when the second power source P2 is initially supplied to the battery module 200A, the service life of the battery module 200A is extended by charging with a small current.

Afterward, optionally, the output switch is turned on (S242). The output switch may be connected in series at the output end of the power conversion circuit 1, and the output switch is only turned on to output the second power source P2 when the bidirectional charger 100 is ready to provide a suitable second power source P2 to start supplying power to the battery module 200A. The above is mainly used for safety protection. If the power conversion circuit 1 does not have this safety protection function, this step can be omitted. Afterward, the battery voltage of the battery module is detected, and it is determined whether the battery voltage is lower than the predetermined voltage (S244). After the bidirectional charger 100 supplies power to the battery module 200A, the control module 2 detects the battery voltage of the battery module 200A, and determines whether the battery module 200A is over-discharged by determining whether the battery voltage is lower than the predetermined voltage.

When the battery voltage is lower than the predetermined voltage, the current upper limit is maintained at the default current (S260). When the battery voltage is lower than the predetermined voltage, it means that the battery module 200A is over-discharged, and the current upper limit needs to be maintained at the default current (for example but not limited to, 1A) to avoid overcurrent charging the over-discharged battery module 200A, thereby reducing the service life of the battery module 200A. Therefore, when the battery voltage is lower than the predetermined voltage, the control module 2 controls the power conversion circuit 1 to provide the second power source P2, and limits the current of the second power source P2 to be lower than the default current (for example but not limited to, 1A).

On the contrary, when the battery voltage is greater than the predetermined voltage, the current upper limit is set to a predetermined current corresponding to the power supplying parameter, and the power conversion circuit 1 is controlled to convert the first power source P1 into the second power source P2 according to the predetermined current (S280). In step (S280), the control module 2 sets the predetermined current according to the selected maximum power supplying parameter. Therefore, when the power supply capacity is below 65W (S281), the control module 2 sets the current upper limit to a predetermined current of 1A (S282); when the power supply capacity is below 100W (S283), the control module 2 sets the current upper limit to a predetermined current of 2A (S284); when the power supply capacity is below 140W (S285), the control module 2 sets the current upper limit to a predetermined current of 2.5A (S286); when the power supply capacity is below 180W (S287), the control module 2 sets the current upper limit to a predetermined current of 3.5A (S288); and when the power supply capacity is above 180W, the control module 2 sets the current upper limit to a predetermined current of 4.5A (S289).

After steps (S260), (S282), (S284), (S286), (S288), and (S289), the control module 2 determines whether the current of the second power source P2 is lower than the threshold current (S300). When the determination result of step (S300) is “no” (for example but not limited to, the current is not less than 0.15A), it means that the battery module 200A is not fully charged, so it returns to step (S244). On the contrary, the operation of the sink mode SK is ended (S320). In step (S320), there are multiple subsequent operation steps, which are not limited here. For example but not limited to, the control module 2 can disable the power conversion circuit 1 so that the power conversion circuit 1 does not convert the first power source P1 into the second power source P2. Alternatively, the control module 2 can control the output switch to turn off so as not to provide the second power source P2, or the control module 2 can control the power conversion circuit 1 to operate in a constant voltage mode and other operation modes.

FIG. 5C is a flowchart of a method of failing to determine an electronic device by the bidirectional charger according to the present disclosure, and also refer to FIG. 1 to FIG. 5A. In FIG. 5C, the electronic device 300 is plugged into the Type-C port 100A of the bidirectional charger 100, and the bidirectional charger 100 confirms that the electronic device is connected, but cannot confirm whether the electronic device is a power supplying device or a power receiving device (S420). In the operation of step (S420), the operation method is similar to steps (S100) to (S120). However, if the electronic device and the control module 2 are both dual roles (such as but not limited to, devices that can both supplying power and feeding power, such as laptops), the situation where both parties cannot confirm their own identities will occur so that the control module 2 cannot confirm whether the electronic device 300 is a power supplying device 300A or a power receiving device 300B.

Afterward, the control module 2 can optionally set the electronic device as a dual-role device (S422). When the control module 2 cannot confirm the type of the electronic device 300, the control module 2 can selectively temporarily mark the electronic device 300 as a dual-role device. Afterward, enter step (S440) to reperform the handshake communication to redetermine whether the electronic device 300 is a power supplying device 300A or a power receiving device 300B, and count the number of times the electronic device 300 is redetermined. In step (S440), since the control module 2 cannot determine the type of the electronic device 300 in step (S420), it starts to count and sets a count value to 0 (S441). Afterward, the handshake communication is performed, and it is confirmed whether the handshake communication is completed (S442). When the determination result of step (S442) is “no”, it means that there is an unforeseen problem with the handshake communication Sh itself, and therefore return to step (S420) and reperform the process of FIG. 5C.

On the contrary, when the determination result of step (S442) is “yes”, it is determined whether the electronic device 300 is a power supplying device 300A or a power receiving device 300B according to the handshake result (S443). When the determination result is “yes”, it means that the control module 2 confirms that the electronic device 300 is a power supplying device 300A or a power receiving device 300B, and therefore the operation mode of the power conversion circuit 1 is set to the sink mode SK or the source mode SO (S460). This situation may occur when the electronic device 300 is a dual-role device, and the electronic device 300 may set itself as a power supplying device 300A or a power receiving device 300B when it cannot determine whether the connected device (i.e., the bidirectional charger 100) requires charging or power-feeding. Alternatively, it may be that an unforeseen error occurred in the previous handshake communication Sh and the type of the electronic device 300 could not be determined, but the current handshake communication is successful and confirms that the electronic device 300 is a power supplying device 300A or a power receiving device 300B.

On the contrary, when the determination result of step (S443) is “no”, the count value is accumulated once (S444). The number of times the count value is accumulated represents the number of times the control module 2 redetermines the type of the electronic device 300, and the greater the count value, the more times the redetermination is performed, and vice versa. Afterward, it is determined whether the accumulated count value is greater than an upper limit value (S445). When the determination result of step (S445) is “no”, it returns to step (S442) to reperform the handshake communication Sh. Therefore, when the number of times the type of the electronic device 300 is redetermined is not greater than the upper limit, and the control module 2 determines and confirms that the electronic device 300 is the power receiving device 300B in steps (S443) and (S460), the source mode SO operation method of FIG. 4C may be performed. On the contrary, when the number of times of redetermining the type of the electronic device 300 is not greater than the upper limit, and the control module 2 determines and confirms that the electronic device 300 is the power supplying device 300A in steps (S443) and (S460), the function of FIG. 4B and the sink mode SK operation method of FIG. 5A and FIG. 5B may be performed.

On the contrary, when the determination result of step (S445) is “yes”, it means that the number of times of redetermining the type of the electronic device 300 has exceeded the upper limit (for example but not limited to, 5 times). At this time, the handshake communication is stopped (S446), and the electronic device 300 is set as the power receiving device 300B (S480). After entering step (S480), the source mode SO operation method of FIG. 4C may be performed. Therefore, the operation process of FIG. 5C can solve the problem that the roles of both parties cannot be determined when the bidirectional charger 100 is connected to the electronic device 300, and avoid the situation where roles cannot be confirmed continuously, causing the device to be unusable. In particular, in one embodiment, the detailed processes and steps not described in FIG. 4B to FIG. 5B, and the devices that can perform the operation not described can be combined with reference to FIG. 1 to FIG. 4A or inferred from FIG. 1 to FIG. 4A, and will not be repeated here.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A bidirectional charger configured to couple to a battery module of an electric vehicle and an electronic device, the bidirectional charger comprising:
a power conversion circuit configured to convert a first power source provided by the electronic device into a second power source, or convert the second power source provided by the battery module into the first power source, and
a control module coupled to the power conversion circuit, and configured to selectively set an operation mode of the power conversion circuit to a sink mode or a source mode by performing a handshake communication with the electronic device,
wherein when the control module sets the operation mode to the sink mode through the handshake communication, the control module is configured to control the power conversion circuit to convert the first power source into the second power source to charge the battery module; when the control module sets the operation mode to the source mode through the handshake communication, the control module is configured to control the power conversion circuit to convert the second power source into the first power source to provide power to the electronic device.

2. The bidirectional charger as claimed in claim 1, further comprising:
a module-side connection part coupled to the battery module through a connection cable, and the module-side connection part comprising:
a positive terminal coupled to the power conversion circuit,
a negative terminal coupled to the power conversion circuit, and the power conversion circuit configured to transmit the second power source through the positive terminal and the negative terminal, and
a signal terminal coupled to the control module, and the control module configured to communicate with the battery module through the signal terminal to obtain a battery parameter of the battery module.

3. The bidirectional charger as claimed in claim 1, further comprising:
a connection cable configured to couple to the battery module, and the connection cable comprising:
a positive connection wire coupled to the power conversion circuit,
a negative connection wire coupled to the power conversion circuit, and the power conversion circuit configured to transmit the second power source through the positive connection wire and the negative connection wire,
at least one signal connection wire coupled to the control module, and the control module configured to communicate with the battery module through the at least one signal connection wire to obtain a battery parameter of the battery module,
wherein when the number of the at least one signal connection wire is plural, signal transmission types of the plurality of signal connection wires are different.

4. The bidirectional charger as claimed in claim 1, further comprising:
a housing configured to accommodate the power conversion circuit and the control module,
a first circuit board disposed on an inner surface adjacent to the housing, and configured to dispose the power conversion circuit,
a second circuit board disposed on another inner surface adjacent to the housing opposite to the first circuit board, and configured to dispose a communication circuit, and
a third circuit board disposed between the first circuit board and the second circuit board for configuring to dispose the control module, and coupled to the first circuit board and the second circuit board through a plurality of conductive components.

5. The bidirectional charger as claimed in claim 4, wherein a first accommodation space between the first circuit board and the third circuit board is larger than a second accommodation space between the second circuit board and the third circuit board, and a power inductor and a power capacitor of the power conversion circuit are disposed in the first accommodation space.

6. The bidirectional charger as claimed in claim 4, wherein the number of layers of the first circuit board is greater than that of the second circuit board and the third circuit board.

7. The bidirectional charger as claimed in claim 4, wherein the third circuit board comprises a shielding layer, and the shielding layer is configured to suppress noise generated by the power conversion circuit during operation.

8. The bidirectional charger as claimed in claim 1, wherein the control module obtains a preset battery voltage corresponding to a number of batteries connected in series in the battery module according to a battery parameter of the battery module so as to control the power conversion circuit to provide the second power source to charge the battery module according to the preset battery voltage.

9. The bidirectional charger as claimed in claim 1, further comprising:
a correction module configured to couple to the control module,
wherein the correction module is configured to correct a second battery voltage actually provided by the power conversion circuit according to a first battery voltage preset by the control module so as to correct the second battery voltage to be substantially equal to the first battery voltage.

10. The bidirectional charger as claimed in claim 1, wherein the control module comprises a power delivery controller and a controller; the power delivery controller is configured to perform the handshake communication with the electronic device through a power delivery charging protocol to adjust the first power source, and the controller is configured to adjust the second power source according to a battery parameter of the battery module in the sink mode.

11. The bidirectional charger as claimed in claim 1, wherein when the control module has not yet completed the handshake communication with the electronic device, the control module is configured to control the power conversion circuit to adjust a voltage of the first power source to a default voltage, and when the control module completes the handshake communication with the electronic device and sets the operation mode to the source mode, the control module is configured to control the power conversion circuit to convert the second power source to the first power source that meets requirements of the electronic device to supply power to the electronic device.

12. A charging system configured to couple to a battery module of an electric vehicle, the charging system comprising:
a power supplying device configured to convert an input power into a first power source,
a power conversion circuit configured to convert the first power source provided by the power supplying device into a second power source, and
a control module coupled to the power conversion circuit, and configured to confirm a power supplying capability of the power supplying device to select a maximum power supplying parameter from the power supplying capability by performing a handshake communication with the power supplying device,
wherein the power supplying device knows the power supplying parameter through the handshake communication, and converts the input power into the first power source corresponding to the power supplying parameter.

13. A method of operating a bidirectional charger, the bidirectional charger configured to couple to a battery module of an electric vehicle and an electronic device, and the bidirectional charger comprising a power conversion circuit, the method comprising steps of:
(a) confirming that the electronic device is connected to the bidirectional charger, and determining whether the electronic device is a power supplying device or a power receiving device,
(b1) confirming that the electronic device is the power supplying device, and receiving a first power source provided by the power supplying device,
(c) setting a current upper limit of a second power source provided to the battery module to a default current, and detecting a battery voltage of the battery module,
(d) determining whether the battery voltage is less than a preset voltage, and
(e1) maintaining the current upper limit at the default current according to the battery voltage being less than the preset voltage, and controlling the power conversion circuit to convert the first power source into the second power source according to the default current.

14. The method of operating the bidirectional charger as claimed in claim 13, further comprising steps of:
(b11) confirm a power supplying capability of the power supplying device by performing a handshake communication with the power supplying device, and selecting a maximum power supplying parameter from the power supplying capability to receive the first power source corresponding to the power supplying parameter, and
(e2) setting the current upper limit to a predetermined current corresponding to the power supplying parameter according to the battery voltage not being lower than the predetermined voltage, and controlling the power conversion circuit to convert the first power source into the second power source according to the predetermined current.

15. The method of operating the bidirectional charger as claimed in claim 13, further comprising a step of:
(f) determining whether a current of the second power source is less than a threshold current, and returning to step (d) according to the current being not less than the threshold current.

16. The method of operating the bidirectional charger as claimed in claim 13, further comprising a step of:
(a1) performing a handshake communication with the electronic device, and controlling the power conversion circuit to adjust a voltage of the first power source to a default voltage.

17. The method of operating the bidirectional charger as claimed in claim 13, further comprising a step of:
(b2) confirming that the electronic device is the power receiving device, and controlling the power conversion circuit to convert the second power source into the first power source that meets requirements of the electronic device to supply power to the electronic device.

18. The method of operating the bidirectional charger as claimed in claim 17, further comprising steps of:
(b3) failing to determine whether the electronic device is the power supplying device or the power receiving device,
(g) reperforming the handshake communication to redetermine whether the electronic device is the power supplying device or the power receiving device, and counting the number of times the electronic device is redetermined, and
(h1) setting the electronic device as the power receiving device when the number is greater than an upper limit, and entering step (b2).

19. The method of operating the bidirectional charger as claimed in claim 18, further comprising a step of:
(h2) returning to step (g) when the number is not greater than the upper limit.

20. The method of operating the bidirectional charger as claimed in claim 18, further comprising steps of:
(h3) returning to step (b2) when the number is not greater than an upper limit, and the electronic device is confirmed as the power receiving device, or
(h4) returning to step (b1) when the number is not greater than the upper limit, and the electronic device is confirmed as the power supplying device.
